(19) United States
(12) Patent Application Publication
(10) Pub. No.: US 2024/0061203 A1
(43) Pub. Date: Feb. 22, 2024

(54) DUCT PORT NOZZLE WITH AUXILIARY WIRE PASS-THROUGH THAT PROVIDES ENTRY POINT FOR AUXILIARY WIRE OTHER THAN A DUCT PORT

(71) Applicant: PPC BROADBAND, INC., East Syracuse, NY (US)

(72) Inventors: Nicholas CLAVER, Liverpool, NY (US); Jack SOBEL, East Syracuse, NY (US); Peter BEARD, East Syracuse, NY (US); Gerald Joseph MEIER, Olathe, KS (US)

(73) Assignee: PPC BROADBAND, INC., East Syracuse, NY (US)

(21) Appl. No.: 18/236,493

(22) Filed: Aug. 22, 2023

Related U.S. Application Data
(60) Provisional application No. 63/399,929, filed on Aug. 22, 2022.

(51) Int. Cl. G02B 6/44

(52) U.S. Cl. CPC G02B 6/4459; G02B 6/44775

(57) ABSTRACT

A duct attachment portion structurally configured to receive a cable duct includes: a duct receiving portion; an auxiliary wire entry portion; and an auxiliary wire entry portion seal portion. The auxiliary wire entry portion seal portion is structurally configured to be penetrated by an auxiliary wire passing through the auxiliary wire entry portion; the auxiliary wire is associated with a cable duct; and the auxiliary wire entry portion is configured to provide an entry point for the auxiliary wire separate from the duct receiving portion to optimize use of the first portion, and the auxiliary wire entry portion is configured to improve protection of the auxiliary wire.

### CROSS-REFERENCE TO RELATED APPLICATION

This application claims the benefit of U.S. Provisional Application No. 63/399,929 filed Aug. 22, 2022, pending, the disclosure of which is hereby incorporated by reference herein in its entirety.

### BACKGROUND

The present invention relates generally to devices and systems for terminating ducts at distribution points within a communications network. More particularly, embodiments of the invention relate to coupling ducts to a terminal enclosure and providing a separate entry point for an auxiliary wire associated with one or more of the ducts.

Ducts commonly used in the telecommunication industry are small ducts used for the installation and protection of cables. They are typically used to provide low-friction paths for the installation of cables, such as, for example, fiber optic cables. It is common practice to lay one or more ducts in a desired path and then to populate each duct with one or more communication cables.

At certain points in a network of ducts, it is desirable to terminate a path. In some instances, more than one duct path is terminated at a single location. This might occur where multiple ducts are routed into a building and the contained cables must be distributed. Terminal enclosures couple to the ends of ducts and provide a location for cables to be organized. Terminal enclosures (cabinets) are typically configured to couple to the duct ends such that they cannot be unintentionally removed. In some cases, a nozzle or other smaller receptacle is attached to the cabinet and receives the ducts. Some ducts include an auxiliary wire such as, for example, a tracer wire that is mounted to the exterior of the duct for the purpose of facilitating tracing of the duct from a starting end to a terminal end. For example, a plurality of ducts can be placed in a single trench in the ground and there is a need to identify which terminal end corresponds to a particular starting end of the plurality of ducts. Also, a trace wire can be used to locate buried ducts in the case of there being no other metallic portion of the duct. Some ducts include an auxiliary wire other than a trace wire such as, for example, a grounding wire.

In conventional cabinets, the auxiliary wire enters the cabinet through a separate port than the duct itself. This is undesirable because the port used for the auxiliary wire is unavailable for use by another duct, limiting the number of cables that can enter the cabinet through a set number of ports. In other cases, the auxiliary wire is terminated outside of the cabinet, which can lead to deterioration of the auxiliary wire due to exposure to the environment outside the enclosure.

It may be desirable to provide a cabinet entry system in which auxiliary wires such as trace wires and grounding wires can enter the cabinet without using a port designed for ducts.

### SUMMARY

Embodiments provide a duct attachment portion structurally configured to receive a cable duct, including: a first sub-portion that may be structurally configured to have a duct receiving portion; a second sub-portion that may be structurally configured to be connected to the first sub-portion; an auxiliary wire entry portion that may be structurally configured to receive an auxiliary wire; and an auxiliary wire entry portion seal portion that may be structurally configured to be located between the first sub-portion and the second sub-portion. The duct receiving portion may be structurally configured to receive a first connector portion; the second sub-portion may be structurally configured to receive a second connector portion; the duct receiving portion may be structurally configured to receive a cable duct; the auxiliary wire may be associated with the cable duct; the auxiliary wire entry portion seal portion may be structurally configured to be penetrated by the auxiliary wire passing through the auxiliary wire entry portion; and the auxiliary wire entry portion may be structurally configured to provide an entry point for the auxiliary wire separate from the duct receiving portion to optimize use of the duct attachment portion, and the auxiliary wire entry portion may be structurally configured to improve protection of the auxiliary wire.

In particular embodiments, the duct attachment portion may be structurally configured to be a duct port nozzle.

In particular embodiments, the first sub-portion may be structurally configured to be a nozzle outer body.

In particular embodiments, the second sub-portion may be structurally configured to be a nozzle inner body.

In particular embodiments, the duct receiving portion may be structurally configured to be a port.

In particular embodiments, the duct receiving portion may be a first duct receiving portion, and the duct attachment portion may further comprise a second duct receiving portion.

Particular embodiments may further comprise a sealing portion that may be structurally configured to be positioned between the first sub-portion and the second sub-portion.

In particular embodiments, the auxiliary wire entry portion may be structurally configured to be an auxiliary wire window.

In particular embodiments, the auxiliary wire entry portion may comprise a plurality of auxiliary wire windows.

In particular embodiments, a separate one of the auxiliary wire windows may be provided for each of a plurality of the duct receiving portion.

In particular embodiments, the auxiliary wire entry portion seal portion may be structurally configured to be located adjacent the auxiliary wire entry portion.

In particular embodiments, the duct attachment portion may comprise a plurality of the duct receiving portion, and the duct attachment portion may comprise exactly one of the auxiliary wire entry portion for each of the duct receiving portions.

Embodiments provide a duct attachment portion structurally configured to receive a cable duct, including: a duct receiving portion; an auxiliary wire entry portion that may be structurally configured to receive an auxiliary wire; and an auxiliary wire entry portion seal portion. The duct receiving portion may be structurally configured to receive a cable duct; the auxiliary wire may be associated with the cable duct; the auxiliary wire entry portion seal portion may be structurally configured to be penetrated by the auxiliary wire passing through the auxiliary wire entry portion; and the auxiliary wire entry portion may be structurally configured to provide an entry point for the auxiliary wire separate from the duct receiving portion to optimize use of the duct attachment portion, and the auxiliary wire entry portion may be structurally configured to improve protection of the auxiliary wire.

In particular embodiments, the duct receiving portion may comprise a first sub-portion, and a second sub-portion that may be structurally configured to be connected to the first sub-portion.

In particular embodiments, the duct attachment portion may be structurally configured to be a duct port nozzle.

Particular embodiments may further comprise a first sub-portion that may be structurally configured to receive the duct receiving portion, and a second sub-portion that may be structurally configured to be connected to the first sub-portion.

In particular embodiments, the first sub-portion may be structurally configured to be a nozzle outer body, and the second sub-portion may be structurally configured to be a nozzle inner body.

In particular embodiments, the duct receiving portion may be structurally configured to be a port.

In particular embodiments, the duct receiving portion may be a first duct receiving portion, and the duct attachment portion may further comprise a second duct receiving portion.

In particular embodiments, the auxiliary wire entry portion may be structurally configured to be an auxiliary wire window.

In particular embodiments, the auxiliary wire entry portion may comprise a plurality of auxiliary wire windows.

In particular embodiments, a separate one of the auxiliary wire windows may be provided for each of a plurality of the duct receiving portion.

In particular embodiments, the auxiliary wire entry portion seal portion may be structurally configured to be located adjacent the auxiliary wire entry portion.

In particular embodiments, the duct attachment portion may comprise a plurality of the duct receiving portion, and the duct attachment portion may comprise exactly one of the auxiliary wire entry portion for each of the duct receiving portions.

Embodiments provide a first portion structurally configured to receive a cable duct, including: a duct receiving portion; an auxiliary wire entry portion; and an auxiliary wire entry portion seal portion. The auxiliary wire entry portion seal portion may be structurally configured to be penetrated by an auxiliary wire passing through the auxiliary wire entry portion; the auxiliary wire may be associated with a cable duct; and the auxiliary wire entry portion may be structurally configured to provide an entry point for the auxiliary wire separate from the duct receiving portion to optimize use of the first portion, and the auxiliary wire entry portion may be structurally configured to improve protection of the auxiliary wire.

Particular embodiments may further comprise an auxiliary wire entry portion that may be structurally configured to receive the auxiliary wire.

In particular embodiments, the duct receiving portion may be structurally configured to receive a cable duct.

In particular embodiments, the first portion may be structurally configured to be a duct port nozzle.

In particular embodiments, the duct receiving portion may be a first duct receiving portion, and the first portion may further comprise a second duct receiving portion.

Particular embodiments may further comprise a plurality of auxiliary wire windows.

In particular embodiments, a separate one of the auxiliary wire windows may be provided for each of a plurality of the duct receiving portion.

In particular embodiments, the first portion may comprise a plurality of the duct receiving portion, and the first portion may comprise exactly one auxiliary wire entry portion for each of the duct receiving portions.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a front perspective view of an exemplary duct port nozzle in accordance with various aspects of the disclosure.

FIG. 2 is a front perspective view of the duct port nozzle of FIG. 1 installed in an enclosure.

FIG. 3 is an exploded perspective view of the duct port nozzle of FIG. 1.

FIG. 4 is a front perspective view of the duct port nozzle and enclosure of FIG. 2 with a duct installed.

FIG. 5 is a perspective view of the duct port nozzle and enclosure of FIG. 2 installed in a cabinet.

FIG. 6 is a front view of the duct port nozzle of FIG. 1.

FIG. 7 is a front view of alternate embodiment of a duct port nozzle in accordance with various aspects of the disclosure.

FIG. 8 is a front view of alternate embodiment of a duct port nozzle in accordance with various aspects of the disclosure.

FIG. 9 is a front view of alternate embodiment of a duct port nozzle in accordance with various aspects of the disclosure.

### DETAILED DESCRIPTION OF EMBODIMENTS

Embodiments provide a duct port nozzle having an auxiliary wire entry portion that is structurally configured to provide an entry point for an auxiliary wire separate from a duct receiving portion to optimize use of the duct port nozzle, and the auxiliary wire entry portion is structurally configured to improve protection of the auxiliary wire.

Embodiments of the disclosure allow a duct to be secured to a port of, for example, an optical fiber enclosure or cabinet with a shark tooth style, or other style, coupling allowing for easy connection and disconnection of the duct. In addition, embodiments provide a duct port nozzle (“nozzle”) that allows trace or other auxiliary wires (“auxiliary wires”) to be stripped and pushed through a thin rubber (or other material) sheet, allowing the auxiliary wires to be terminated inside an enclosure and thus be protected and, in some cases, grounded. A nozzle in accordance with embodiments is placed into an enclosure with the couplers facing outward. Duct pieces are inserted into the couplers and the auxiliary wires are pushed through an auxiliary wire window and grounded (or otherwise terminated), if necessary. Embodiments include differently sized duct nozzles and different auxiliary wire window sizes/configurations. Embodiments include the improvement of securing a duct to a nozzle while using the same nozzle to provide access of the auxiliary wire to the enclosure.

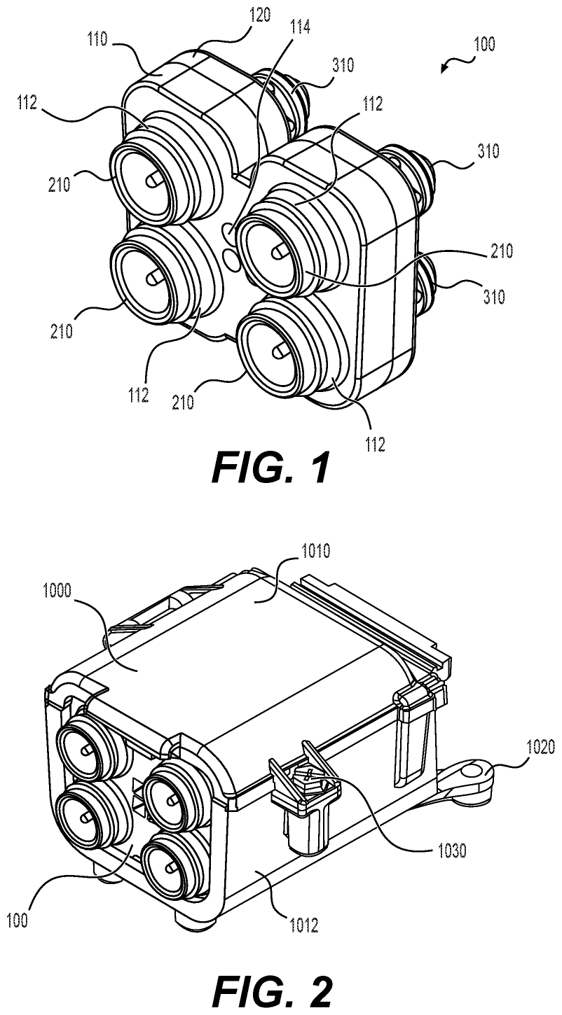

FIG. 1 shows an exemplary first portion such as, for example, a duct attachment portion or a duct port nozzle 100 in accordance with embodiments of the disclosure. Nozzle 100 includes, in this example, a first sub-portion such as, for example, an outer body 110 and a second sub-portion such as, for example, an inner body 120 that are, in some embodiments, attached to each other by one or more fasteners or by another appropriate method. Outer body 110 has a plurality of (in this example, four) duct receiving portions such as, for example, ports 112 that are configured to receive a duct carrying, for example, one or more cables such as, for example, fiber optic cables. In this example, a first connector portion such as, for example, an outer connector part 210 is configured to be received in each port 112 and is configured to anchor the duct to port 112. A second connector portion such as, for example, an inner connector part 310 is configured to be received in a receptacle portion such as, for example, an opening 122 in inner body 120.

FIG. 2 shows nozzle 100 mounted in an enclosure 1000. In embodiments, enclosure 1000 has a first body portion such as, for example, an upper body 1010 that is attached to a second body portion such as, for example, a lower body 1012 such that enclosure 1000 can be opened to install nozzle 100 and to access the cables attached to nozzle 100. In this example, enclosure 1000 has a fastening portion such as, for example, a fastener 1030 that secures upper body 1010 in place on lower body 1012. One or more enclosure attachment portions such as, for example, mounting points 1020 are provided to facilitate mounting enclosure 1000 to a cabinet or a mounting surface.

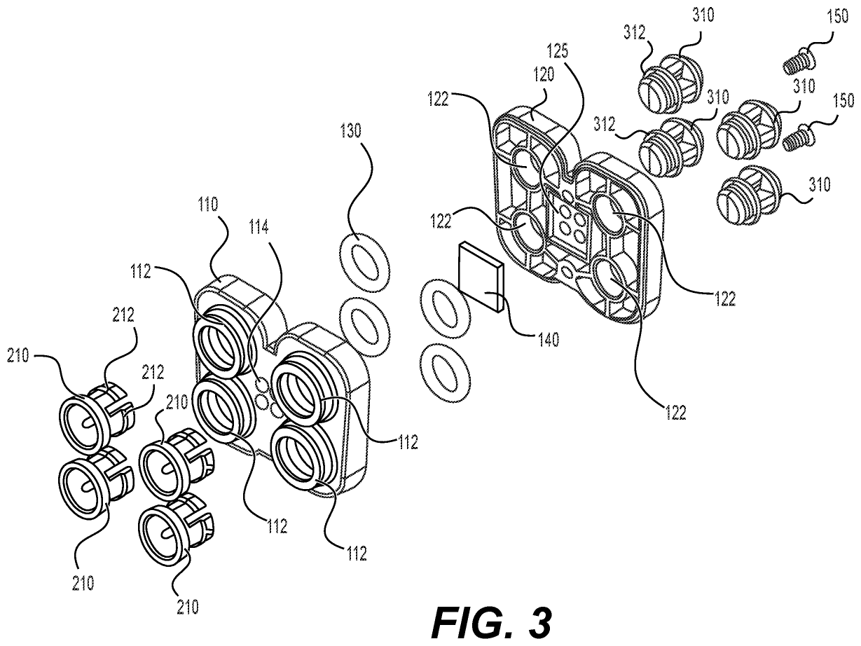

FIG. 3 shows an exploded view of nozzle 100. FIG. 3 shows outer body 110 and inner body 120 being attachable to each other by, in this example, two screws 150. Outer body 110 in this example has four ports 112 that are each structurally configured to receive one outer connector part 210 is, in turn, configured to anchor the duct to port 112. In this example, each outer connector part 210 has four retention portions such as, for example, resilient fingers 212 that snap into engagement with an inner feature of a respective port 112. Each inner connector part 310 is shown with an engagement feature 312 that is configured to engage a respective opening 122 in inner body 120. In this embodiment, a sealing portion such as, for example, an O-ring or other seal 130 is positioned between inner body 120 and outer body 110 to provide a weather-resistant or weatherproof seal.

Also shown in FIG. 3 is an example of an auxiliary wire entry portion seal portion such as, for example, a membrane 140 that is positioned in, in this example, an auxiliary wire entry portion seal portion receiving portion such as, for example, a recess 125 in inner body 120. One or more auxiliary wire entry portions such as, for example, auxiliary wire windows 114 is provided in outer body 110 and align with membrane 140. In embodiments, the installer of a duct in nozzle 100 pushes an auxiliary wire through membrane 140 creating a hole in membrane 140. In embodiments, membrane 140 includes a plurality of pieces of, for example, a rubber or other material membrane, that have edges that abut one another and/or overlap one another. In such embodiments, the installer pushes the auxiliary wire through membrane 140 through one of the areas where the pieces of material abut or overlap one another. In embodiments, membrane 140 creates a weather-resistant or weatherproof seal around the auxiliary wire. While FIG. 3 shows auxiliary wire window 114 being four round openings, other embodiments include a different number of auxiliary wire windows and/or auxiliary wire windows having different shapes and sizes. In this example, four auxiliary wire windows are provided in order to provide one auxiliary wire window 114 for each port 112 in nozzle 100.

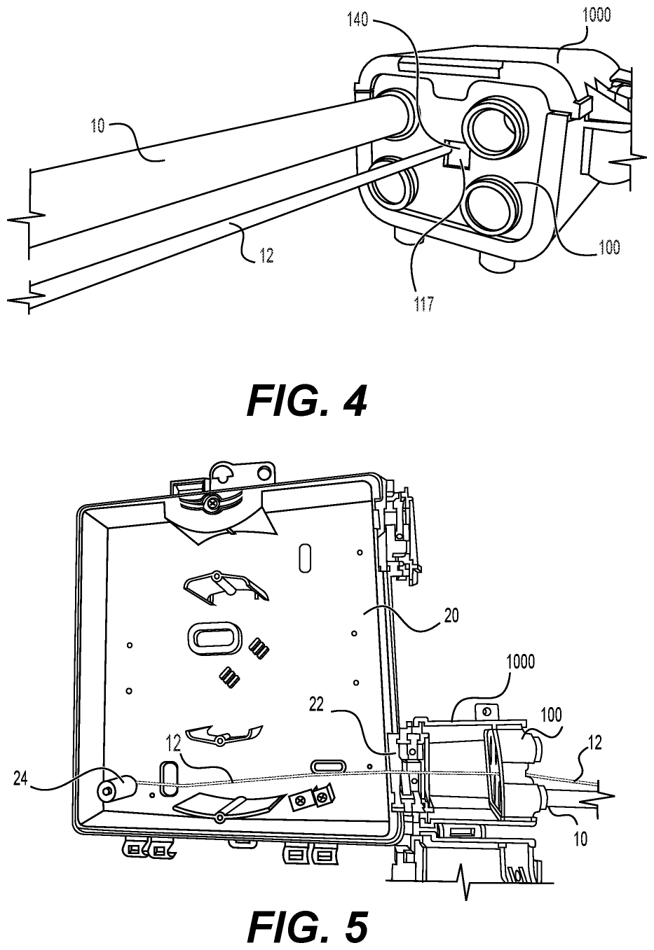

FIG. 4 shows a duct 10 and an auxiliary wire 12 attached to nozzle 100. In FIG. 4, auxiliary wire 12 is shown entering nozzle 100 and enclosure 1000 through an auxiliary wire entry portions such as, for example, auxiliary wire window 117. Auxiliary wire window 117 is one large window (See FIG. 9) as opposed to the four smaller windows shown in FIG. 1. Due to the large size of auxiliary wire window 117, membrane 140 can be seen in FIG. 4. While only one duct 10 and one auxiliary wire 12 are shown in FIG. 4, in use, up to four ducts 10 and four corresponding auxiliary wires 12 can be attached to nozzle 100. While nozzle 100 shown in the drawings has four ports 112, other embodiments have fewer or more than four ports 112. In embodiments, one auxiliary wire window is provided for each port 112 in nozzle 100.

FIG. 5 shows enclosure 1000 mounted to a cabinet 20 and an opening 22. Both enclosure 1000 and cabinet 20 are shown without their upper bodies or covers so that the paths of duct 10 and auxiliary wire 12 can be clearly seen. As can be seen in FIG. 5, nozzle 100 is mounted in enclosure 1000 and duct 10 is attached to nozzle 100. Auxiliary wire 12 passes through auxiliary wire window 114 and membrane 140 to extend through enclosure 1000 and into cabinet 20. In this example, auxiliary wire 12 is terminated at a termination post 24 inside cabinet 20. Although not shown, fiber optic cables in duct 10 are received in cabinet 20 and then spliced, terminated, or otherwise managed inside cabinet 20. As discussed above, up to four (in this example) cables are received by cabinet 20 through nozzle 100. In embodiments, ducts 10 are structurally configured to hold one or more cables each.

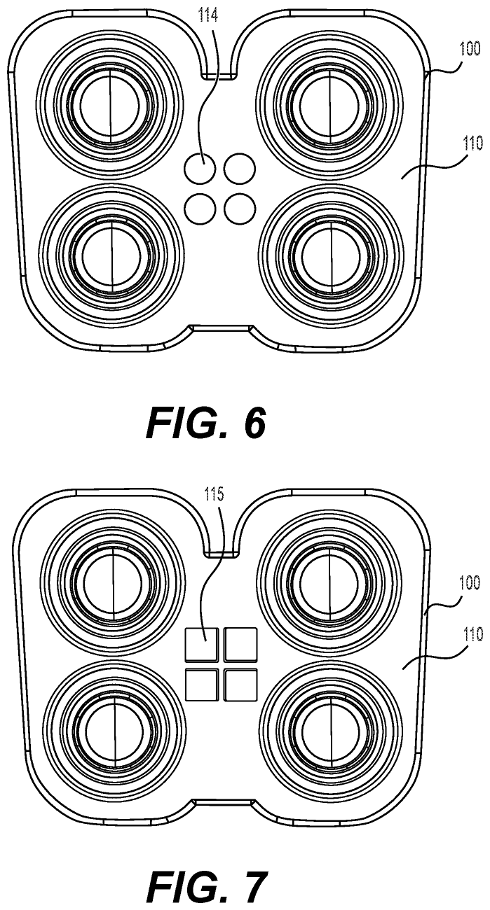

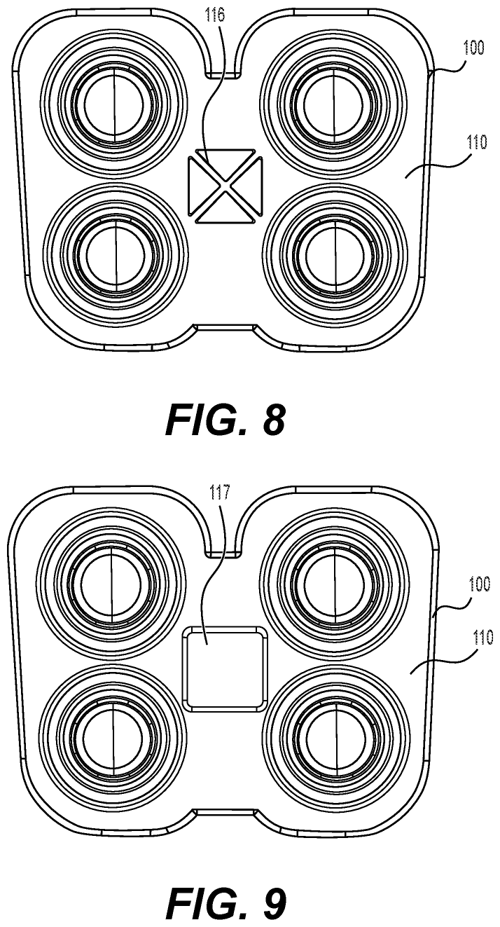

FIG. 6 shows nozzle 100 having four round auxiliary wire windows 114 as shown in FIG. 1. Other embodiments include other shapes, sizes, and numbers of auxiliary wire windows. For example, the embodiment shown in FIG. 7 has four square auxiliary wire entry portions such as, for example, auxiliary wire windows 115. In another example, the embodiment shown in FIG. 8 has four triangular auxiliary wire entry portions such as, for example, auxiliary wire windows 116. In another example, the embodiment shown in FIG. 9 has one square auxiliary wire window 117. Having smaller auxiliary wire windows (such as in FIGS. 6-8) provide support for membrane 140 including when the auxiliary wires are pushed through membrane 140. In embodiments, the installer of duct 10 in nozzle 100 pushes auxiliary wire 12 through membrane 140 creating a hole in membrane 140. Having additional structure around the hole made by the installer can help avoid a large tear or other rupture of membrane 140. Additionally, having one auxiliary wire window 114-116 for each auxiliary wire 12 provides an indication and/or reminder to the installer that each auxiliary wire 12 should penetrate membrane 140 at its own location/hole.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A duct attachment portion structurally configured to receive a cable duct, comprising:
a first sub-portion that is structurally configured to have a duct receiving portion;
a second sub-portion that is structurally configured to be connected to the first sub-portion;
an auxiliary wire entry portion that is structurally configured to receive an auxiliary wire;
an auxiliary wire entry portion seal portion that is structurally configured to be located between the first sub-portion and the second sub-portion;
wherein the duct receiving portion is structurally configured to receive a first connector portion;
wherein the second sub-portion is structurally configured to receive a second connector portion;
wherein the duct receiving portion is structurally configured to receive a cable duct;
wherein the auxiliary wire is associated with the cable duct;
wherein the auxiliary wire entry portion seal portion is structurally configured to be penetrated by the auxiliary wire passing through the auxiliary wire entry portion; and
wherein the auxiliary wire entry portion is configured to provide an entry point for the auxiliary wire separate from the duct receiving portion to optimize use of the duct attachment portion, and the auxiliary wire entry portion is configured to improve protection of the auxiliary wire.

2. The duct attachment portion of claim 1, wherein the duct attachment portion is structurally configured to be a duct port nozzle.

3. The duct attachment portion of claim 1, wherein the first sub-portion is structurally configured to be a nozzle outer body.

4. The duct attachment portion of claim 1, wherein the second sub-portion is structurally configured to be a nozzle inner body.

5. The duct attachment portion of claim 1, wherein the duct receiving portion is structurally configured to be a port.

6. The duct attachment portion of claim 1, wherein the duct receiving portion is a first duct receiving portion, and the duct attachment portion further comprises a second duct receiving portion.

7. The duct attachment portion of claim 1, further comprising a sealing portion that is structurally configured to be positioned between the first sub-portion and the second sub-portion.

8. The duct attachment portion of claim 1, wherein the auxiliary wire entry portion is structurally configured to be an auxiliary wire window.

9. The duct attachment portion of claim 1, wherein the auxiliary wire entry portion comprises a plurality of auxiliary wire windows.

10. The duct attachment portion of claim 9, wherein a separate one of the auxiliary wire windows is provided for each of a plurality of the duct receiving portion.

11. The duct attachment portion of claim 1, wherein the auxiliary wire entry portion seal portion is structurally configured to be located adjacent the auxiliary wire entry portion.

12. The duct attachment portion of claim 1, wherein the duct attachment portion comprises a plurality of the duct receiving portion, and the duct attachment portion comprises exactly one of the auxiliary wire entry portion for each of the duct receiving portions.

13. A duct attachment portion structurally configured to receive a cable duct, comprising:
a duct receiving portion;
an auxiliary wire entry portion that is structurally configured to receive an auxiliary wire;
an auxiliary wire entry portion seal portion;
wherein the duct receiving portion is structurally configured to receive a cable duct;
wherein the auxiliary wire is associated with the cable duct;
wherein the auxiliary wire entry portion seal portion is structurally configured to be penetrated by the auxiliary wire passing through the auxiliary wire entry portion; and
wherein the auxiliary wire entry portion is configured to provide an entry point for the auxiliary wire separate from the duct receiving portion to optimize use of the duct attachment portion, and the auxiliary wire entry portion is configured to improve protection of the auxiliary wire.

14. The duct attachment portion of claim 13, wherein the duct receiving portion comprises a first sub-portion, and a second sub-portion that are structurally configured to be connected to the first sub-portion.

15. The duct attachment portion of claim 13, wherein the duct attachment portion is structurally configured to be a duct port nozzle.

16. The duct attachment portion of claim 13, further comprising a first sub-portion that is structurally configured to receive the duct receiving portion, and a second sub-portion that is structurally configured to be connected to the first sub-portion.

17. The duct attachment portion of claim 16, wherein the first sub-portion is structurally configured to be a nozzle outer body, and the second sub-portion is structurally configured to be a nozzle inner body.

18. The duct attachment portion of claim 13, wherein the duct receiving portion is structurally configured to be a port.

19. The duct attachment portion of claim 13, wherein the duct receiving portion is a first duct receiving portion, and the duct attachment portion further comprises a second duct receiving portion.

20. The duct attachment portion of claim 13, wherein the auxiliary wire entry portion is structurally configured to be an auxiliary wire window.

21. The duct attachment portion of claim 13, wherein the auxiliary wire entry portion comprises a plurality of auxiliary wire windows.

22. The duct attachment portion of claim 21, wherein a separate one of the auxiliary wire windows is provided for each of a plurality of the duct receiving portion.

23. The duct attachment portion of claim 13, wherein the auxiliary wire entry portion seal portion is structurally configured to be located adjacent the auxiliary wire entry portion.

24. The duct attachment portion of claim 13, wherein the duct attachment portion comprises a plurality of the duct receiving portion, and the duct attachment portion comprises exactly one of the auxiliary wire entry portion for each of the duct receiving portions.

25. A first portion structurally configured to receive a cable duct, comprising:
a duct receiving portion;
an auxiliary wire entry portion;
an auxiliary wire entry portion seal portion;
wherein the auxiliary wire entry portion seal portion is structurally configured to be penetrated by an auxiliary wire passing through the auxiliary wire entry portion;
wherein the auxiliary wire is associated with a cable duct; and
wherein the auxiliary wire entry portion is configured to provide an entry point for the auxiliary wire separate from the duct receiving portion to optimize use of the first portion, and the auxiliary wire entry portion is configured to improve protection of the auxiliary wire.

26. The first portion of claim 25, further comprising an auxiliary wire entry portion that is structurally configured to receive the auxiliary wire.

27. The first portion of claim 25, wherein the duct receiving portion is structurally configured to receive a cable duct.

28. The first portion of claim 25, wherein the first portion is structurally configured to be a duct port nozzle.

29. The first portion of claim 25, wherein the duct receiving portion is a first duct receiving portion, and the first portion further comprises a second duct receiving portion.

30. The first portion of claim 25, further comprising a plurality of auxiliary wire windows.

31. The first portion of claim 30, wherein a separate one of the auxiliary wire windows is provided for each of a plurality of the duct receiving portion.

32. The first portion of claim 25, wherein the first portion comprises a plurality of the duct receiving portion, and the first portion comprises exactly one auxiliary wire entry portion for each of the duct receiving portions.
